(19) United States
(12) Patent Application Publication
(10) Pub. No.: US 2014/0008585 A1
(43) Pub. Date: Jan. 9, 2014

(54) SULFONATED POLY(ETHER ETHER KETONE) INTERMEDIATE TRANSFER MEMBERS

(71) Applicant: Jin Wu, Pittsford, NY (US)

(72) Inventor: Jin Wu, Pittsford, NY (US)

(73) Assignee: XEROX CORPORATION, Norwalk, CT (US)

(21) Appl. No.: 13/543,851

(22) Filed: Jul. 8, 2012

(51) Int. Cl. C08G 75/24; H01B 1/20; C08L 81/08; H01B 1/24

(52) U.S. Cl. 252/511; 252/519.33; 252/500; 525/390; 524/540; 524/539

(57) ABSTRACT

An intermediate transfer member that includes a sulfonated poly(ether ether ketone) polymer, an optional conductive component, an optional polymer, and an optional release additive.

This disclosure is generally directed to an intermediate transfer member that includes a sulfonated poly(ether ether ketone) (SPEEK) and an intermediate transfer member that contains a mixture of a sulfonated poly(ether ether ketone), an optional conductive filler component, an optional internal release additive, and an optional polymer binder.

### BACKGROUND

There are known extruded or inflated intermediate transfer members that include certain thermoplastics that are insoluble or substantially insoluble in a number of known solvents, such as dimethyl sulfoxide, N-methyl-2-pyrrolidone, N,N-dimethylformamide, N,N-dimethylacetamide, and the like. Thus, the preparation of dispersions of thermoplastic polymers, such as poly(ether ether ketones) and conductive component intermediate transfer members is not advantageous, and may not be achievable.

Also, there are known intermediate transfer members that include materials with characteristics that cause these members to become brittle resulting in inadequate acceptance of the developed image, and subsequent partial transfer of developed xerographic images to a substrate like paper.

A further disadvantage relating to the preparation of an intermediate transfer member is that there is usually deposited a separate release layer on a metal substrate, and thereafter, there is applied to the release layer the intermediate transfer member components, and where the release layer allows the components to be separated from the member by peeling, or by the use of mechanical devices. Thereafter, the intermediate transfer member components in the form of a film can be selected for xerographic imaging systems, or where the film can be deposited on a supporting substrate like a polymer layer. The use of a separate intermediate release layer adds to the cost and to the time of preparation of intermediate transfer members, and such a layer can also modify a number of the intermediate transfer member characteristics.

It is known that carbon black can be used as the conductive particles in several intermediate transfer belts, however, carbon black can be difficult to disperse since there are very few polar groups on the surface, and unless they are specially modified on the surface. Also, it can be difficult to generate carbon black based intermediate transfer belts with consistent resistivity because the required loading is present on the vertical part of the percolation curve, and the working window for carbon black is very narrow. In addition, in humid environments, moisture will tend to deposit on the intermediate transfer member during idle and cause wrinkles, transfer failures and print defects.

There is a need for intermediate transfer members that substantially avoid or minimize the disadvantages of a number of known intermediate transfer members.

Further, there is a need for intermediate transfer member films that can be prepared by solution casting processes.

Another need resides in the provision of intermediate transfer member films where the polymers utilized are soluble or substantially soluble in a number of known solvents.

A further need resides in providing intermediate transfer member materials with acceptable resistivity, high modulus and excellent break strength leading to developed images with minimal resolution issues for extended time periods.

Also, there is a need for intermediate transfer member materials that possess self-release characteristics from a number of substrates that are selected when such members are prepared.

Moreover, there is a need for the solution casting preparation of intermediate transfer members that contain polymers that are soluble in various solvents, and which members possess improved stability with no or minimal degradation for extended time periods.

Additionally, there is a need for intermediate transfer member containing components that include novel soluble polymers that can be economically and efficiently manufactured.

Further, there is a need for intermediate transfer members with a combination of excellent resistivity, acceptable mechanical properties inclusive of extended time period toughness, stable substantially consistent characteristics.

These and other needs are achievable in embodiments with the intermediate transfer members, and components thereof disclosed herein.

### SUMMARY

Disclosed is an intermediate transfer member comprising a sulfonated poly(ether ether ketone).

Also, disclosed is an intermediate transfer member comprising a sulfonated poly(ether ether ketone), a conductive component, a polysiloxane, and an optional internal release additive, wherein the sulfonated poly(ether ether ketone) is represented by the following formulas/structures

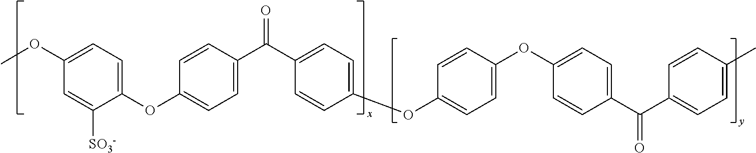

where x and y are the mole respective percents of the repeating units with x being from about 10 to about 95 mole percent, y being from about 5 to about 90 mole percent, and the sum of x plus y is equal to about 100 mole percent.

Yet further disclosed is a sulfonated poly(ether ether ketone) generated from the reaction of a source of sulfur and a poly(ether ether ketone).

### FIGURES

The following Figures are provided to further illustrate the intermediate transfer members disclosed herein.

FIG. 1 illustrates an exemplary embodiment of a one-layer intermediate transfer member of the present disclosure.

FIG. 2 illustrates an exemplary embodiment of a two-layer intermediate transfer member of the present disclosure.

FIG. 3 illustrates an exemplary embodiment of a three-layer intermediate transfer member of the present disclosure.

### EMBODIMENTS

There is disclosed herein an intermediate transfer member comprising a sulfonated poly(ether ether ketone) (SPEEK) and mixtures or blends thereof with suitable optional polymers, such as polysiloxanes and fluoropolymers, optional internal release additives, and a conductive filler component.

The disclosed sulfonated poly(ether ether ketones) are soluble in organic solvents such as dimethyl sulfoxide, N-methyl-2-pyrrolidone, N,N-dimethylformamide, N,N-dimethylacetamide and acetone enabling the effective dispersions thereof with conductive compounds such as carbon blacks, and assists in enabling self-release of intermediate transfer member films from substrates like a metal substrate, such as stainless steel, thereby avoiding the need for a separate costly release layer on the substrate.

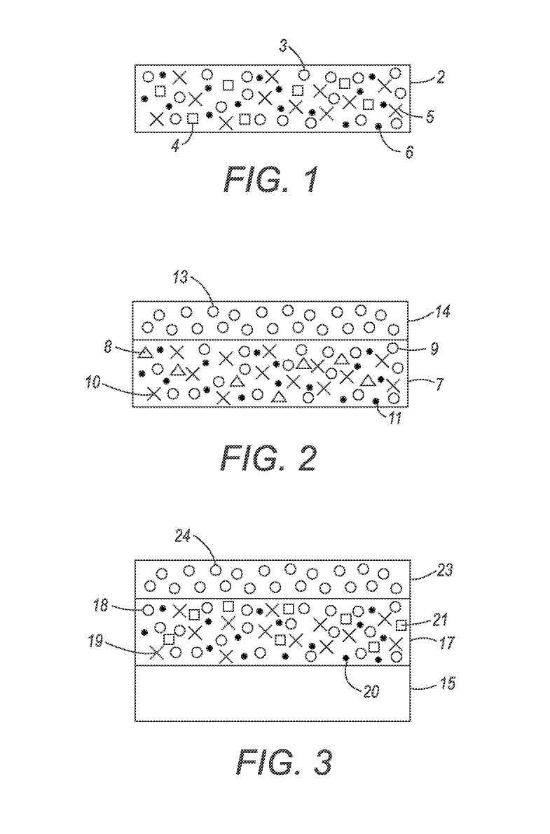

In FIG. 1 there is illustrated an intermediate transfer member comprising a layer 2 of a mixture of a sulfonated poly(ether ether ketone) 3, an optional polymer binder 4, an optional release additive 5, and an optional conductive component 6.

In FIG. 2 there is illustrated a two-layer intermediate transfer member comprising a bottom layer 7 of a sulfonated poly(ether ether ketone) 8, an optional polymer 9, an optional release additive 10, and an optional conductive component 11, and an optional top or outer toner release layer 14 comprising film releasing components 13.

In FIG. 3 there is illustrated a three layer intermediate transfer member comprising a supporting substrate 15, a layer 17 of a sulfonated poly(ether ether ketone) 18, an optional polysiloxane polymer 19, an optional release additive 21, and an optional conductive component 20, and an optional release layer 23 comprising film releasing components 24.

The intermediate transfer members disclosed herein exhibit self-release characteristics, and where the use of an external release layer present on, for example, a stainless steel substrate is avoided; have excellent mechanical strength while permitting the rapid and complete transfer of from about 90 to about 99 percent, and from about 95 to about 100 percent transfer of a xerographic developed image from a photoconductor in a xerographic imaging process and xerographic apparatus; possess a Young's modulus of, for example, from about 1,000 to about 3,000 Mega Pascals (MPa), from about 1,200 to about 2,700 MPa, or from about 1,500 to about 2,500 MPa; a break strength of from about 30 to about 100 MPa, from about 40 to about 100 Mpa, or from about 35 to about 70 MPa; and a desirable resistivity as measured with a known High Resistivity Meter of, for example, from about 10⁸ to about 10¹³ ohm/square, from about 10⁹ to about 10¹³ ohm/square, from about 10⁹ to about 10¹² ohm/square, or from about 10⁹ to about 10¹⁰ ohm/square.

Self-release characteristics without the assistance of any external sources, such as prying devices, permits the efficient, economical formation, and full separation, from about 85 to about 100 percent, or from about 90 to about 99 percent of the disclosed intermediate transfer member films from metal substrates, and where release materials and separate release layers can be avoided. The time period to obtain the self-release characteristics of the disclosed intermediate transfer layer films varies depending, for example, on the components present, and the amounts thereof selected for the sulfonated poly(ether ether ketone) polymer layer. Generally, however, the release time period is from about 1 to about 65 seconds, from about 1 to about 50 seconds, from about 1 to about 35 seconds, from about 1 to about 20 seconds, or from about 1 to about 5 seconds, and in some instances less than 1 second.

The intermediate transfer members of the present disclosure can be provided in any of a variety of configurations, such as a one-layer configuration, or in a multi-layer configuration including, for example, a top release layer. More specifically, the final intermediate transfer member may be in the form of an endless flexible belt, a web, a flexible drum or roller, a rigid roller or cylinder, a sheet, a drelt (a cross between a drum and a belt), a seamless belt that is with an absence of any seams or visible joints in the members, and the like.

Sulfonated Poly(ether ether ketones) (SPEEK)

The disclosed novel sulfonated poly(ether ether ketones) and the complex structures thereof, which may perhaps be determined by a number of known techniques, such as NMR, can be prepared by the sulfonation, with heating at elevated temperatures, of a mixture of a source of sulfur like sulfuric acid and commercially available VICTREX® poly(ether ether ketone), and allowing the reaction mixture to cool to room temperature of from about 23° C. to about 27° C. where there is formed a solution of the sulfonated poly(ether ether ketone), which can be precipitated from water, isolated by filtration, and thermally dried afterwards.

The number average molecular weight of the sulfonated poly(ether ether ketone) is from about 40,000 to about 150,000, or from about 60,000 to about 100,000, and the weight average molecular weight of the sulfonated poly(ether ether ketone) is from about 80,000 to about 250,000, or from about 120,000 to about 180,000, each as determined by Gel Permeation Chromatography (GPC).

The sulfonated poly(ether ether ketone) (SPEEK) can be represented by the following formulas/structures

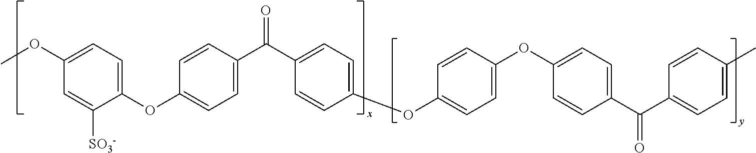

where x and y are the mole percent of the repeating units, x is from about 10 to about 95 mole percent, or from about 30 to about 80 mole percent; y is from about 5 to about 90 mole percent, or from about 20 to about 70 mole percent, and the sum of x plus y is equal to about 100 mole percent.

In one embodiment, commercially available poly(ether ether ketone) (PEEK) pellets can be added to a source of sulfur, such as bulk sulfuric acid, with the weight ratio of the PEEK to the source of sulfur being from about 1/2 to about 1/10, and subsequently the resulting mixture can be vigorously stirred for a time period of from about 2 to about 18 hours, or from about 7 to about 12 hours at a temperature of from about 40° C. to about 80° C., or from about 55° C. to about 70° C. During the heating, sulfonate groups can be attached to the benzene ring between the two ether bonds of the PEEK polymer resulting in a dark brown solution. The sulfonated poly(ether ether ketone) product can be isolated by precipitation into, for example, cool water, and can be washed several times to remove residual acids in the precipitate. The SPEEK polymer was subsequently dried, and analyzed for its chemical structures by NMR and for molecular weights by GPC.

Examples of the commercially available poly(ether ether ketone) (PEEK) polymers selected as a reactant include VICTREX® PEEK 90G, 150G, 450G, 150FC30, 450FC30, 150FW30, 450FE20, WG101, WG102, ESD101, all available from VICTREX Manufacturing Limited.

Examples of solvents selected for the formation of the excellent dispersions of the coating mixtures containing the soluble sulfonated poly(ether ether ketones), which solvents can be selected in an amount of, for example, from about 60 to about 90 weight percent, or from about 70 to about 80 weight percent of the total mixture components include alkylene halides, such as methylene chloride, tetrahydrofuran, toluene, halobenzenes such as monochlorobenzene, N-methyl-2-pyrrolidone, N,N-dimethylformamide, N,N-dimethylacetamide, methyl ethyl ketone, dimethylsulfoxide, methyl isobutyl ketone, formamide, acetone, ethyl acetate, cyclohexanone, acetanilide, mixtures thereof, and the like. Diluents can be mixed with the solvents selected for the intermediate transfer member mixtures. Examples of diluents added to the solvents in amounts of from about 1 to about 25 weight percent, and from 1 to about 10 weight percent based on the weight of the solvent and the diluent are known diluents like aromatic hydrocarbons, ethyl acetate, cyclohexanone and acetanilide.

Excellent sulfonated poly(ether ether ketone) dispersions, especially dispersions containing mixtures of conductive materials like carbon black and the disclosed sulfonated poly(ether ether ketone) refers for example, to the sulfonated poly(ether ether ketone) being soluble in a suitable solvent of for example, the solvents as illustrated herein and where the solubility is from about 90 to about 100 percent, from about 90 to about 98 percent, or from about 95 to about 97 percent.

Sulfur Sources

In addition to sulfuric acid, a number of known sulfur sources can be selected for the sulfonation of the poly(ether ether ketone) such as sulfur trioxide, sulfamic acid, chlorosulfonic acid, oleum, and the like.

The sulfuric acid can be of a number of different concentrations, such as from about 10 to about 98 percent, from about 20 to about 80 percent, from about 30 to about 65 percent, and other known concentrations, and fuming sulfuric acid can also be selected as a reactant. Usually the sulfuric acid is used in excess such as a PEEK/sulfuric acid ratio of from about 3/1 to about 1/20, or from about 1/1 to about 1/10.

Optional Polymers

The intermediate transfer member mixture can also comprise optional suitable known polymers like a polysiloxane polymer functioning primarily as leveling agents or binders. Examples of polysiloxane polymers selected for the intermediate transfer member mixture disclosed herein include known suitable polysiloxanes, such as a polyether modified polydimethylsiloxane, commercially available from BYK Chemical as BYK® 333, BYK® 330 (about 51 weight percent in methoxypropylacetate), BYK® 344 (about 52.3 weight percent in xylene/isobutanol, ratio of 80/20), BYK®-SILCLEAN 3710 and BYK® 3720 (about 25 weight percent in methoxypropanol); a polyester modified polydimethylsiloxane, commercially available from BYK Chemical as BYK® 310 (about 25 weight percent in xylene) and BYK® 370 (about 25 weight percent in xylene/alkylbenzenes/cyclohexanone/monophenylglycol, ratio of 75/11/7/7); a polyacrylate modified polydimethylsiloxane, commercially available from BYK Chemical as BYK®-SILCLEAN 3700 (about 25 weight percent in methoxypropylacetate); a polyester polyether modified polydimethylsiloxane, commercially available from BYK Chemical as BYK® 375 (about 25 weight percent in di-propylene glycol monomethyl ether), and mixtures thereof.

The polysiloxane polymer or copolymers thereof can be present in the intermediate transfer member mixture in various effective amounts, such as from about 0.01 to about 1 weight percent, from about 0.05 to about 1 weight percent, from about 0.05 to about 0.5 weight percent, or from about 0.1 to about 0.3 weight percent based on the weight percent of the solid components present in the mixture, such as the components of the synthesized sulfonated poly(ether ether ketone), the optional polysiloxane polymer, the optional internal release additive, and when present the conductive component.

Optional Release Additives

A number of known optional internal release additives present in various effective amounts, such as in an amount of, for example, from about 0.05 to about 10 weight percent, from about 0.01 to about 10 weight percent, from about 0.1 to about 5 weight percent, from about 0.2 to about 2 weight percent, from about 0.1 to 3.5 weight percent or from about 0.1 to about 2.5 weight percent, and where the weight percent is based on the weight percent of the total solids, can be included in the disclosed intermediate transfer member mixture to further assist in the release of the member from metal substrates. Examples of internal release additives incorporated into the sulfonated poly(ether ether ketones) or dispersions thereof include acid functionalized fluoro components of carboxylic acid functionalized fluoro components such as octafluoroadipic acid, dodecafluorosuberic acid, hexadecafluorosebacic acid, heptadecafluoro-n-nonanoic acid, nonadecafluorodecanoic acid, nonafluorovaleric acid, pentadecafluorooctanoic acid, undecafluorohexanoic acid, and mixtures thereof; or phosphate esters of alkylphenoxy polyethoxyethanols, such as commercially available STEPFAC® like STEPFAC® 8171, and the like.

Optional Fillers

Optionally, the intermediate transfer member may contain one or more component fillers to, for example, alter and adjust the conductivity of the intermediate transfer member. Where the intermediate transfer member is a one layer structure, the conductive filler can be included in the sulfonated poly(ether ether ketone) layer disclosed herein. However, when the intermediate transfer member is a multi-layer structure, the conductive filler can be included in one or more layers of the member, such as in the supporting substrate, the sulfonated poly(ether ether ketone) or sulfonated poly(ether ether ketone) containing mixture thereof layer and in both the supporting substrate and the sulfonated poly(ether ether ketone) layer or mixtures thereof.

Various effective suitable fillers can be used that provide the desired results. For example, suitable fillers include carbon blacks, metal oxides, polyanilines, other known suitable fillers, and mixtures of fillers.

Examples of carbon black fillers that can be selected for the intermediate transfer members illustrated herein include special black 4 (B.E.T. surface area=180 m²/g, DBP absorption=1.8 ml/g, primary particle diameter=25 nanometers) available from Evonik-Degussa, special black 5 (B.E.T. surface area=240 m²/g, DBP absorption=1.41 ml/g, primary particle diameter=20 nanometers), color black FW1 (B.E.T. surface area=320 m²/g, DBP absorption=2.89 ml/g, primary particle diameter=13 nanometers), color black FW2 (B.E.T. surface area=460 m²/g, DBP absorption=4.82 ml/g, primary particle diameter=13 nanometers), color black FW200 (B.E.T. surface area=460 m²/g, DBP absorption=4.6 ml/g, primary particle diameter=13 nanometers), all available from Evonik-Degussa; VULCAN® carbon blacks, REGAL® carbon blacks, MONARCH® carbon blacks and BLACK PEARLS® carbon blacks available from Cabot Corporation. Specific examples of conductive carbon blacks are BLACK PEARLS® 1000 (B.E.T. surface area=343 m²/g, DBP absorption=1.05 ml/g), BLACK PEARLS® 880 (B.E.T. surface area=240 m²/g, DBP absorption=1.06 ml/g), BLACK PEARLS® 800 (B.E.T. surface area=230 m²/g, DBP absorption=0.68 ml/g), BLACK PEARLS® L (B.E.T. surface area=138 m²/g, DBP absorption=0.61 ml/g), BLACK PEARLS® 570 (B.E.T. surface area=110 m²/g, DBP absorption=1.14 ml/g), BLACK PEARLS® 170 (B.E.T. surface area=35 m²/g, DBP absorption=1.22 ml/g), VULCAN® XC72 (B.E.T. surface area=254 m²/g, DBP absorption=1.76 ml/g), VULCAN® XC72R (fluffy form of VULCAN® XC72), VULCAN® XC605, VULCAN® XC305, REGAL® 660 (B.E.T. surface area=112 m²/g, DBP absorption=0.59 ml/g), REGAL® 400 (B.E.T. surface area=96 m²/g, DBP absorption=0.69 ml/g), REGAL® 330 (B.E.T. surface area=94 m²/g, DBP absorption=0.71 ml/g), MONARCH® 880 (B.E.T. surface area=220 m²/g, DBP absorption=1.05 ml/g, primary particle diameter=16 nanometers), and MONARCH® 1000 (B.E.T. surface area=343 m²/g, DBP absorption=1.05 ml/g, primary particle diameter=16 nanometers); special carbon blacks available from Evonik Incorporated; and Channel carbon blacks available from Evonik-Degussa. Other known suitable carbon blacks not specifically disclosed herein may be selected as the filler or conductive component for the intermediate transfer members disclosed herein.

Examples of polyaniline fillers that can be selected for incorporation into the intermediate transfer member compositions are PANIPOL™ F, commercially available from Panipol Oy, Finland, and known lignosulfonic acid grafted polyanilines. These polyanilines usually have a relatively small particle size diameter of, for example, from about 0.5 to about 5 microns; from about 1.1 to about 2.3 microns, or from about 1.5 to about 1.9 microns.

Metal oxide fillers that can be selected for the disclosed intermediate transfer member composition include, for example, tin oxide, antimony doped tin oxide, indium oxide, indium tin oxide, zinc oxide, and titanium oxide, and the like.

When present, the filler can be selected in an amount of, for example, from about 1 to about 60 weight percent, from about 3 to about 40 weight percent, from about 4 to about 30 weight percent, from about 10 to about 30 percent, from about 3 to about 30 weight percent, from about 5 to about 30 weight percent, from about 8 to about 25 weight percent, or from about 13 to about 20 weight percent of the weight percent of the total solids of the synthesized sulfonated poly(ether ether ketone), and which sulfonated poly(ether ether ketone) is present in an amount of from about 60 to about 97 weight percent, or from about 70 to about 90 weight percent based on the ingredients present. The ratio of the sulfonated poly(ether ether ketone) to the conductive component, such as carbon black, is for example, from about 95/5 to about 60/40 or from about 90/10 to about 80/20.

Adhesive Layer

Adhesive layer components usually situated between the supporting substrate, and the sulfonated poly(ether ether ketone) containing layer thereover include, for example, a number of resins or polymers of epoxy, urethane, silicone, polyester, and the like. Generally, the adhesive layer is a solventless layer, that is materials that are liquid at room temperature (about 25° C.), and are able to crosslink to an elastic, or rigid film to adhere at least two materials together. Specific adhesive layer components include 100 percent solids adhesives including polyurethane adhesives obtained from Lord Corporation, Erie, Pa., such as TYCEL® 7924 (viscosity from about 1,400 to about 2,000 cps), TYCEL® 7975 (viscosity from about 1,200 to about 1,600 cps), and TYCEL® 7276. The viscosity range of the adhesives is, for example, from about 1,200 to about 2,000 cps. The solventless adhesives can be activated with either heat, room temperature curing, moisture curing, ultraviolet radiation, infrared radiation, electron beam curing, or any other known technique. The thickness of the adhesive layer is usually less than about 100 nanometers, and more specifically, for example, from about 1 to about 100 nanometers, from about 5 to about 75 nanometers, or from about 50 to about 100 nanometers.

Optional Release Layer

When desired, an optional release layer can be included over the sulfonated poly(ether ether ketone) containing layer illustrated herein. The release layer may be included to assist in providing additional toner cleaning, and further developed image transfer efficiency from a photoconductor to the intermediate transfer member.

The release layer can have any desired and suitable thickness. For example, the release layer can have a thickness of from about 1 to about 100 microns, from about 10 to about 75 microns, or from about 20 to about 50 microns.

The optional release layer can comprise TEFLON®-like materials including fluorinated ethylene propylene copolymer (FEP), polytetrafluoroethylene (PTFE), polyfluoroalkoxy polytetrafluoroethylene (PFA TEFLON®), and other TEFLON®-like materials; silicone materials, such as fluorosilicones and silicone rubbers, such as Silicone Rubber 552, available from Sampson Coatings, Richmond, Va. (polydimethyl siloxane/dibutyl tin diacetate, 0.45 gram DBTDA per 100 grams polydimethyl siloxane rubber mixture with a molecular weight M_{w} of approximately 3,500); and fluoroelastomers, such as those sold as VITON®, such as copolymers and terpolymers of vinylidenefluoride, hexafluoropropylene, and tetrafluoroethylene, which are known commercially under various designations as VITON A®, VITON E®, VITON E60C®, VITON E45®, VITON E430®, VITON B910®, VITON GH®, VITON B50®, and VITON GF®. The VITON® designation is a Trademark of E.I. DuPont de Nemours, Inc. Two known fluoroelastomers are comprised of (1) a class of copolymers of vinylidenefluoride, hexafluoropropylene, and tetrafluoroethylene, known commercially as VITON A®; (2) a class of terpolymers of vinylidenefluoride, hexafluoropropylene, and tetrafluoroethylene, known commercially as VITON B®; and (3) a class of tetrapolymers of vinylidenefluoride, hexafluoropropylene, tetrafluoroethylene, and a cure site monomer, such as VITON GF®, having 35 mole percent of vinylidenefluoride, 34 mole percent of hexafluoropropylene, and 29 mole percent of tetrafluoroethylene with 2 percent cure site monomer. The cure site monomers can be those available from E.I. DuPont de Nemours, Inc. such as 4-bromoperfluorobutene-1,1,1-dihydro-4-bromoperfluorobutene-1,3-bromoperfluoropropene-1,1,1-dihydro-3-bromoperfluoropropene-1, or commercially available cure site monomers.

Intermediate Transfer Member Formation

The sulfonated poly(ether ether ketone) or mixtures thereof illustrated herein comprising, for example, a solution of the generated sulfonated poly(ether ether ketone), a conductive filler component, an optional polymer, and an optional internal release additive can be formulated into an intermediate transfer member by any suitable method, inclusive of known solution casting processes. For example, with known milling processes, the sulfonated poly(ether ether ketone) or uniform dispersions of the sulfonated poly(ether ether ketone) intermediate transfer member mixtures can be obtained. The dispersion obtained can then be coated on a metal substrate such as stainless steel using known coating methods such as flow coating or draw bar coating. The resulting individual film, films or belts can be dried at high temperatures, such as by heating and drying the films or belts, such as by heating at about 60° C. to about 250° C., from about 90° C. to about 220° C., or from about 120° C. to about 190° C., for a suitable time period of, for example, from about 30 to 180 minutes, from about 45 minutes to about 120 minutes, or from about 35 to about 90 minutes, or curing by heating the intermediate transfer member mixture to from about 80° C. to about 250° C., or from about 140° C. to about 175° C., while remaining on the substrate. After drying and cooling to room temperature, about 23° C. to about 25° C., the films or belts self-release from the steel substrates, that is the film or belt releases without any external assistance. The resultant intermediate transfer film or belt product can have a thickness of, for example, from about 15 to about 150 microns, from about 20 to about 100 microns, from about 50 to about 65 microns, and more specifically about 60 microns.

Solution casting processes for the preparation of the disclosed intermediate transfer members usually utilize centrifugal forces by adding the sulfonated poly(ether ether ketone)/carbon black dispersion with optional polymers and optional release additives onto a metal spinning head, and where the centrifugal force spreads the dispersion into intermediate transfer films.

As substrates selected for the deposition of the sulfonated poly(ether ether ketone) or the sulfonated poly(ether ether ketone) mixtures disclosed herein, there can be selected stainless steel, aluminum, nickel, copper, and their alloys, glass, and other conventional typical known materials.

Optional Supporting Substrates

An optional supporting substrate can be included in the intermediate transfer member, such as beneath the generated sulfonated poly(ether ether ketone) containing layer. An optional supporting substrate can be included to provide increased rigidity or strength to the intermediate transfer member.

Examples of the intermediate transfer member supporting substrates are polyimides inclusive of known low temperature, and rapidly cured polyimide polymers, such as VTEC™ PI 1388, 080-051, 851, 302, 203, 201, and PETI-5, all available from Richard Blaine International, Incorporated, Reading, Pa., polyamideimides, polyetherimides, and the like The thermosetting polyimides can be cured at temperatures of from about 180° C. to about 260° C. over a short period of time, such as from about 10 to about 120 minutes, or from about 20 to about 60 minutes, and generally have a number average molecular weight of from about 5,000 to about 500,000 or from about 10,000 to about 100,000, and a weight average molecular weight of from about 50,000 to about 5,000,000 or from about 100,000 to about 1,000,000. Also, for the supporting substrate there can be selected thermosetting polyimides that can be cured at temperatures of above 300° C., such as PYRE M.L.® RC-5019, RC 5057, RC-5069, RC-5097, RC-5053, and RK-692, all commercially available from Industrial Summit Technology Corporation, Parlin, N.J.; RP-46 and RP-50, both commercially available from Unitech LLC, Hampton, Va.; DURIMIDE® 100, commercially available from FUJIFILM Electronic Materials U.S.A., Inc., North Kingstown, R.I.; and KAPTON® HN, VN and FN, all commercially available from E.I. DuPont, Wilmington, Del.

Examples of polyamideimides that can be selected as supporting substrates for the intermediate transfer members disclosed herein are VYLOMAX® HR-11NN (15 weight percent solution in N-methylpyrrolidone, T_{g}=300° C., and M_{w}=45,000), HR-12N2 (30 weight percent solution in N-methylpyrrolidone/xylene/methyl ethyl ketone=50/35/15, T_{g}=255° C., and M_{w}=8,000), HR-13NX (30 weight percent solution in N-methylpyrrolidone/xylene=67/33, T_{g}=280° C., and M_{w}=10,000), HR-15ET (25 weight percent solution in ethanol/toluene=50/50, T_{g}=260° C., and M_{w}=10,000), HR-16NN (14 weight percent solution in N-methylpyrrolidone, T_{g}=320° C., and M_{w}=100,000), all commercially available from Toyobo Company of Japan, and TORLON® AI-10 (T_{g}=272° C.), commercially available from Solvay Advanced Polymers, LLC, Alpharetta, Ga.

Examples of specific polyetherimide supporting substrates that can be selected for the intermediate transfer members disclosed herein are ULTEM® 1000 (T_{g=210}° C.), 1010 (T_{g=217}° C.), 1100 (T_{g=217}° C.), 1285, 2100 (T_{g=217}° C.), 2200 (T_{g=217}° C.), 2210 (T_{g=217}° C.), 2212 (T_{g=217}° C.), 2300 (T_{g=217}° C.), 2310 (T_{g=217}° C.), 2312 (T_{g=217}° C.), 2313 (T_{g=217}° C.), 2400 (T_{g=217}° C.), 2410 (T_{g=217}° C.), 3451 (T_{g=217}° C.), 3452 (T_{g=217}° C.), 4000 (T_{g=217}° C.), 4001 (T_{g=217}° C.), 4002 (T_{g=217}° C.), 4211 (T_{g=217}° C.), 8015, 9011 (T_{g=217}° C.), 9075, and 9076, all commercially available from Sabic Innovative Plastics.

Once formed, the supporting substrate can have any desired and suitable thickness. For example, the supporting substrate can have a thickness of from about 10 to about 300 microns, such as from about 50 to about 150 microns, from about 75 to about 125 microns, or about 80 microns.

The intermediate transfer members illustrated herein can be utilized for a number of printing and copying systems, inclusive of xerographic printing systems that contain photoconductors. For example, the disclosed intermediate transfer member can be incorporated into a multi-imaging xerographic machine where each developed toner image to be transferred is formed on a photoconductor at an image forming station, and where each of these images is then developed with a toner at a developing station, and transferred to the intermediate transfer member. Also, the images may be formed on a photoconductor and developed sequentially, and then transferred to the intermediate transfer member. In an alternative method, each image may be formed on the photoconductor, developed, and then transferred in registration to the intermediate transfer member. The multi-image stage system in embodiments can be a color copying system, wherein each color of an image being copied is formed on a photoconductor, developed with toners, and then transferred to the intermediate transfer member.

After the toner latent image has been transferred from the photoconductor to the intermediate transfer member, the intermediate transfer member may be contacted under heat and pressure with an image receiving substrate such as paper. The toner image on the intermediate transfer member is then transferred and fixed by heat in image configuration to a document, such as paper.

Specific embodiments will now be described in detail. These examples are intended to be illustrative, and are not limited to the materials, conditions, or process parameters set forth in these embodiments. All parts are percentages by weight of total solids of all the components unless otherwise indicated.

### Example I

### Synthesis of Sulfonated Poly(Ether Ether Ketone) (SPEEK)

Experimentally, 20 grams of the poly(ether ether ketone) VICTREX® 150G pellets were added to 200 grams of bulk sulfuric acid, followed by vigorously stirring for 4 hours at 60° C. During this procedure, sulfonate groups were attached to the benzene ring between the two ether bonds of the PEEK polymer as determined by NMR analysis, and a dark brown solution was obtained. The resulting sulfonated poly(ether ether ketone) (SPEEK) was obtained by the dropping precipitation of the dark brown solution into cool water, and washing several times with distilled water to remove residual acids in the precipitation. The obtained SPEEK polymer was dried in vacuum oven at 60° C. for 24 hours, and allowed to cool to room temperature.

Thereafter, the sulfonated poly(ether ether ketone) polymer product had a number average molecular weight of 85,000 and a weight average molecular weight of 161,000 as determined by Gel Permeation Chromatography with a sulfonation extent or amount of sulfur being about 66 mole percent as determined by NMR.

Preparation of SPEEK Intermediate Transfer Member by Solution Casting

The above prepared synthetic SPEEK was dissolved in dimethylsulfoxide (DMSO) at about 10 percent solids, and ball milled with carbon black (special black 4, B.E.T. surface area=180 m²/g, DBP absorption=1.8 ml/g, primary particle diameter=25 nanometers, available from Evonik-Degussa), the weight ratio of the SPEEK to carbon black being 88/12. To the resulting dispersion was then added 0.05 percent by weight of BYK® 333, a polyether modified polydimethylsiloxane commercially available from BYK Chemical, as the surface leveling agent, and the final coating dispersion was filtered through a 20 micron Nylon cloth.

The above prepared dispersion was coated on a stainless steel sheet substrate, and dried at 120° C. for 20 minutes, and then 200° C. for additional 40 minutes. The resulting SPEEK intermediate transfer member comprising SPEEK/Special Black 4/BYK® 333 in a ratio of 87.95/12/0.05 was about 60 microns thick and immediately, about one second, self-released from the stainless steel substrate without the need to apply an additional release layer on the stainless steel.

### Example II

An intermediate transfer member is prepared by repeating the processes of Example I except that there is selected in place of the dimethyl sulfoxide solvent, acetone, N-methyl-2-pyrrolidone, N,N-dimethylformamide, or N,N-dimethylacetamide, and substantially similar products and similar results are believed to be obtainable.

### Measurements

The resistivity of the above Example I intermediate transfer member film were measured using a High Resistivity Meter.

The above intermediate transfer member of Example I was also measured for Young's Modulus following the known ASTM D882-97 process. A sample (0.5 inch×12 inch) of the intermediate transfer member was placed in the Instron Tensile Tester measurement apparatus, and then the sample was elongated at a constant pull rate until breaking. During this time, there was recorded the resulting load versus the sample elongation. The Young's Modulus was calculated by taking any point tangential to the initial linear portion of the recorded curve results and dividing the tensile stress by the corresponding strain. The tensile stress was calculated by the load divided by the average cross sectional area of each of the test samples. Break strength was measured by the tensile stress when the sample broke.

The data obtained per the above measurements is shown in Table 1.

TABLE 1

| | Surface Resistivity | Young's Modulus | Break Strength |
|---|---|---|---|
| | (Ohm/Sq) | (Mpa) | (Mpa) |
| Example I | 3.1 × 10⁹ | 1,900 | 41 |

### Comparative Example 1

An intermediate transfer member could not be prepared by repeating the solution casting process of Example when there was selected poly(ether ether ketone) as a replacement for the sulfonated poly(ether ether ketone), in that the poly(ether ether ketone) (PEEK) was insoluble in the dimethyl sulfoxide.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

1. An intermediate transfer member that consists of a sulfonated poly(ether ether ketone), a conductive component, and a polysiloxane and wherein said sulfonated poly(ether ether ketone) possesses a weight average molecular weight of from about 80,000 to about 250,000, and a number average molecular weight of from about 40,000 to about 150,000 as determined by Gel Permeation Chromatography and wherein said sulfonated poly(ether ether ketone) has a solubility of from about 90 to about 100 percent in a solvent selected from the group consisting of dimethylsulfoxide, acetone, N-methyl-2-pyrrolidone, N,N-dimethylformamide, and N,Ndimethylacetamide,

2. The intermediate transfer member in accordance with claim 1 wherein said solvent is dimethyl sulfoxide.

3. The intermediate transfer member in accordance with claim 1 wherein said sulfonated poly(ether ether ketone) has a solubility of from about 90 to about 98 percent and said solvent is dimethyl sulfoxide

4. The intermediate transfer member in accordance with claim 1 wherein said sulfonated poly(ether ether ketone) is represented by the following formulas/structures and is free of sodium and hydrogen 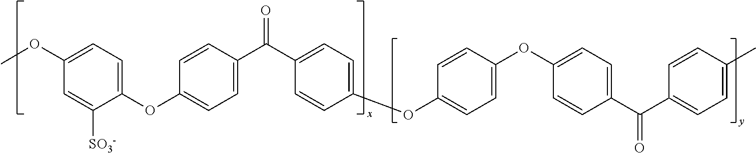
where x and y are the mole respective percents of the repeating units with x being from about 10 to about 95 mole percent, y being from about 5 to about 90 mole percent, and the sum of x plus y equal to about 100 mole percent.

5. The intermediate transfer member in accordance with claim 4 wherein x is from about 30 to about 80 mole percent, and y is from about 20 to about 70 mole percent.

6. The intermediate transfer member in accordance with claim 1 wherein said conductive component is selected from the group consisting of carbon black, a metal oxide, a polyaniline, and mixtures thereof.

7. The intermediate transfer member in accordance with claim 6 wherein said sulfonated poly(ether ether ketone) is present in an amount of from about 60 to about 97 weight percent based on the ingredients present, and said conductive component is present in an amount of from about 3 to about 40 weight percent based on the ingredients present, and wherein the total thereof is about 100 weight percent.

8. (canceled)

9. The intermediate transfer member in accordance with claim 1 wherein said polysiloxane is selected from the group consisting of a polyether modified polydimethylsiloxane, a polyester modified polydimethylsiloxane, a polyacrylate modified polydimethylsiloxane, a polyester polyether modified polydimethylsiloxane, and mixtures thereof.

10. The intermediate transfer member in accordance with claim 8 wherein said polysiloxane is present in an amount of from about 0.01 to about 1 weight percent of the total solids.

11. The intermediate transfer member in accordance with claim 1 wherein said sulfonated poly(ether ether ketone) has a solubility of from about 95 to about 97 percent in dimethyl sulfoxide.

12. The intermediate transfer member in accordance with claim 1 wherein said sulfonated poly(ether ether ketone) possesses a weight average molecular weight of 161,000 and a number average molecular weight of 85,000 as determined by Gel Permeation Chromatography.

13. The intermediate transfer member in accordance with claim 1 wherein said sulfonated poly(ether ether ketone) possesses a weight average molecular weight of from about 120,000 to about 180,000, and a number average molecular weight of from about 60,000 to about 100,000 as determined by Gel Permeation Chromatography and which sulfonated poly(ether ether ketone) is free of sodium and hydrogen.

14. A xerographic intermediate transfer member that consists of a sulfonated poly(ether ether ketone), a conductive component, and a polysiloxane, and an internal release additive, wherein said sulfonated poly(ether ether ketone) is represented by the following formulas/structures and is free of sodium and hydrogen 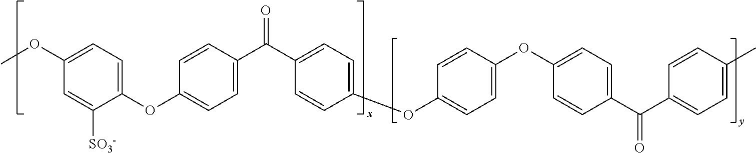
wherein x and y are the respective mole percents of the repeating units, x being from about 10 to about 95 mole percent, y being from about 5 to about 90 mole percent, and where the sum of x plus y is about 100 mole percent, wherein said sulfonated poly(ether ether ketone) possesses a weight average molecular weight of from about 80,000 to about 250,000, and a number average molecular weight of from about 40,000 to about 150,000 as determined by Gel Permeation Chromatography and wherein said sulfonated poly(ether ether ketone) has a solubility in dimethyl sulfoxide of from about 90 to about 100 percent.

15. The intermediate transfer member in accordance with claim 14 wherein x is from about 30 to about 80 mole percent, and y is from about 20 to about 70 mole percent.

16. The intermediate transfer member in accordance with claim 14 wherein said member possesses a Young's Modulus of from about 1,000 to about 3,000 Mega Pascals.

17. The intermediate transfer member in accordance with claim 14 wherein said member possesses a break strength of from about 40 to about 100 Mega Pascals.

18. The intermediate transfer member in accordance with claim 14 wherein said conductive component is carbon black.

19. An intermediate transfer member that consists of a sulfonated poly(ether ether ketone), a carbon black conductive component and a polysiloxane wherein said sulfonated poly(ether ether ketone) possesses a weight average molecular weight of from about 120,000 to about 180,000, and a number average molecular weight of from about 60,000 to about 100,000 as determined by Gel Permeation Chromatography and wherein said sulfonated poly(ether ether ketone) has a solubility in dimethyl sulfoxide of from about 90 to about 100 percent.

20. The intermediate transfer member in accordance with claim 19 wherein a ratio of said sulfonated poly(ether ether ketone), to said carbon black conductive component to said polysiloxane is 87.95/12/0.05 and wherein sodium and hydrogen are not present in said sulfonated poly (ether ether ketone).
